(19) United States
(12) Patent Application Publication
(10) Pub. No.: US 2005/0098995 A1
(43) Pub. Date: May 12, 2005

(54) Gas bag

(75) Inventor: Anton Fischer, Leinweiler (DE)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Automotive GmbH

(21) Appl. No.: 10/981,279

(22) Filed: Nov. 4, 2004

(30) Foreign Application Priority Data
Nov. 11, 2003 (DE) 103 52 666.8

(51) Int. Cl. B60R 21/16

(52) U.S. Cl. 280/743.2

(57) ABSTRACT

Gas bag (10) for a vehicle occupant restraint system comprises first and second fabric layers (12, 14) lying one over another and at least one limiting means delimiting the spacing between the fabric layers (12, 14) in the inflated state of the gas bag, which is fastened to the fabric layers (12, 14). The limiting means in the folded state of the gas bag consists of a seam (16) with at least three threads (18, 20, 22), at least one of the threads (22) being constructed as a tear thread.

### FIELD OF THE INVENTION

The invention relates to a gas bag for a vehicle occupant restraint system comprising first and second fabric layers superimposed on each other, and at least one tether means defining a spacing between the fabric layers in the inflated condition of the gas bag, which is secured to the first and second fabric layers.

### BACKGROUND OF THE INVENTION

The expansion of a gas bag can be influenced and controlled for example by internal tethers. These tethers are respectively arranged between two fabric layers lying one over another and are sewn to these or woven by a special weaving technique. In each case, the arrangement of the internal tethers requires a considerable manufacturing expenditure. When the tethers are secured to the fabric layers by seams, these seams must be introduced through the inflation port of the gas bag. The weaving of the internal tethers with the superimposed fabric layers requires a special weaving technique which is very costly and complex.

U.S. Pat. No. 6,457,745 B1 therefore suggests to construct the internally arranged tether means by at least one seam constructed with thread slack. The thread slack of the seam forms loops in the folded condition of the gas bag, which are arranged between the fabric layers or on the outer surface of one of the fabric layers. With the expansion of the gas bag, the thread slack is drawn out until the loops are eliminated. The plurality of taut threads inside the gas bag acts like a tether which delimits the expansion of the gas bag in the direction of extent of the threads. The production of interior loops, however, requires the use of spacers in the production of the gas bag, which means an increased manufacturing expenditure.

In a gas bag for head protection, finally, in the entire restraint region, i.e. the region in which striking by a vehicle occupant is to be expected, a sufficient gas thickness is to be available which is as constant as possible. Currently, gas bags for head protection are divided into several restraint chambers by nip seams, i.e. a connection of the fabric layers by means of a simple seam, in order to also ensure a reliable restraining effect with different striking directions of the head onto the gas bag. In so doing, however, the possibility of a striking of the occupant's head onto a nip seam has to be ruled out, because at this point no air cushion is available.

### SUMMARY OF THE INVENTION

By comparison, the invention provides a gas bag in which also in the region of the nip seams a residual air bag thickness or an air cushion is present in the case of restraint. Therefore, in a simple manner, a sufficient gas bag thickness is provided over the entire restraint region. Furthermore, the gas bag according to the invention can be produced with simple manufacturing techniques.

For this, according to the invention, a gas bag is provided for a vehicle occupant restraint system comprising first and second fabric layers superimposed on each other, and at least one tether means defining a spacing between the first and second fabric layers in the inflated condition of the gas bag and being secured to the first and second fabric layers, which is characterized in that the tether means in the folded state of the gas bag comprises a seam having at least three threads, at least one of the threads being constructed as a tear thread. Such a seam can be constructed without further auxiliary means with a conventional sewing machine.

On inflating of the gas bag, the seam thread constructed as a tear thread breaks and thus makes possible a loosening of the seam formed by the other two threads or the production of a thread slack during the inflation process. The expansion of the gas bag is delimited in direction of extent of these threads. Hence, however, an air cushion can form between the first and second fabric layers in the region of the seam. Therefore, it is possible without greater expenditure to maintain a division of the gas bag into several restraint chambers and through the construction of the nip seams comprising a seam in the described manner to nevertheless provide a residual thickness of the gas bag.

Preferably, the seam is formed by at least two under-threads which are spaced apart from each other, and an upper thread running between the under-threads, the tear thread being one of the under-threads. A particularly simple embodiment makes provision that the under-threads are arranged on the outer side, i.e. the side facing the exterior of the gas bag, of one of the fabric layers, whereas the upper thread is arranged on the outer side of the other fabric layer and runs between the under-threads in a zigzag pattern. This embodiment is therefore similar to a conventional zigzag stitch. The residual gas bag thickness is established here in a simple manner by the spacing of the under-threads or the stitch rows, with which the under-threads are connected to the fabric layer. The seam pattern can be produced on commercially available sewing machines. Therefore, however, the construction of complex seam geometries is also possible without increased manufacturing expenditure.

Preferably the tear thread or the under-threads constructed as a tear thread has a thickness of about 0.1 mm or less. With thicker threads, the danger exists that the tear thread does not tear reliably or damages the gas bag fabric. The remaining threads of the seam are preferably at least about 0.5 mm thick, in order to be able to effectively delimit the expansion of the gas bag.

### BRIEF DESCRIPTION OF THE DRAWINGS

Further advantages and features of the invention will be apparent from the following description of an embodiment of the invention with reference to the enclosed drawings. In the drawings:

FIG. 1 shows a diagrammatic illustration of two fabric layers which are connected with each other by a seam consisting of three threads, and

FIG. 2 shows a diagrammatic illustration of the gas bag in the inflated state.

### DETAILED DESCRIPTION OF A PREFERRED EMBODIMENT

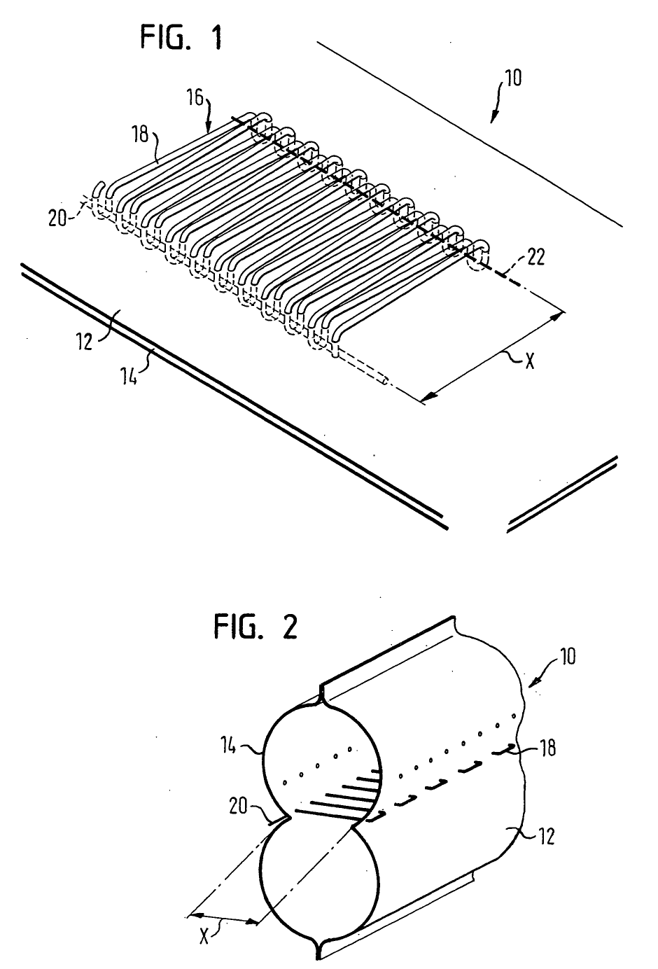

The section of a gas bag 10, shown in FIG. 1 in the condition when spread out flat, has first and second fabric layers 12, 14 lying one over another, which can be constructed in one part or sewn together on the edge side. The first and second fabric layers 12, 14 are connected with each other by a seam 16, which extends linearly over a section of the surface area of the gas bag 10. The seam 16 is in place of an internal tether of conventional gas bag constructions or in place of conventional nip seams.

In the embodiment illustrated here, the seam 16 consists of an upper thread 18, and two under-threads 20, 22 arranged at a lateral distance X from each other. The under-threads 20, 22 are arranged on the outer surface of the second or lower fabric layer 14 in FIG. 1 and run substantially parallel to each other. The upper thread 18 connects the under-threads 20, 22 to the second fabric layer 14 and runs on the outer surface of the first or upper fabric layer 12 in FIG. 1 in a zigzag pattern between the under-threads 20, 22.

The upper thread 18 and the under-thread 20 are constructed to have a thickness of approximately 0.5 mm or more. The under-thread 22 is formed as a tear thread having a thickness of approximately 0.1 mm or less.

On inflating the gas bag 10, the under-thread 22 tears owing to the rising internal pressure in the gas bag and frees the stitch row formed on the under-thread 22. Thereby, loops form which with the further expansion of the gas bag are drawn through the stitch row formed at the under-thread 20, until the loops are eliminated. This is the case, for instance, when the spacing X of the first and second fabric layers 12, 14 upon inflation of the gas bag approximately equals the spacing X of the under-threads 20, 22 or of the stitch rows formed at these threads in the condition when the gas bag is spread out flat. The spacing between the first and second fabric layers 12, 14 and hence the residual gas bag thickness, can therefore already be controlled in this way in a simple manner by means of the manufacturing process.

The production of the seam 16 can take place by simple sewing methods, for example similar to a conventional zigzag stitch, without additional process steps being necessary, such as for example the introduction of spacers into the gas bag. In the folded condition, the seam 16 lies closely against the outer surface of the fabric layers 12, 14, so that no risk exists of an impairment to function by a tangling of thread slack or loops.

The invention is not restricted to the seam pattern described here. It is conceivable, for example, that the under-threads 20, 22 are arranged on opposite outer surfaces of the first and second fabric layers and/or that the upper thread runs on both outer surfaces of the fabric layers 12, 14.

1. A gas bag (10) for a vehicle occupant restraint system, comprising first and second fabric layers (12, 14) superimposed on each other, and at least one tether means defining a spacing between the first and second fabric layers (12, 14) in an inflated condition of the gas bag (10), which is secured to the first and second fabric layers (12, 14), characterized in that the tether means, in a condition of the gas bag (10) when spread out flat, comprises a seam (16) having at least three threads (18, 20, 22), at least one of the threads (22) being constructed as a tear thread.

2. The gas bag according to claim 1, characterized in that the seam (16) is formed by at least two under-threads (20, 22), laterally spaced apart from each other, and an upper thread (18) running between the under-threads (20, 22), the tear thread being one of the under-threads (22).

3. The gas bag according to claim 2, characterized in that the spacing of the first and second fabric layers (12, 14) in the inflated condition amounts to approximately the spacing of the under-threads (20, 22) in the condition of the gas bag when spread out flat.

4. The gas bag according to claim 2, characterized in that the at least two under-threads (20, 22) are arranged externally on the second fabric layer (14) and the upper thread (18) is arranged externally on the first fabric layer (12) and runs in a zigzag pattern in the spacing between the under-threads (20, 22).

5. The gas bag according to claim 1, characterized in that the tear thread has a thickness of about 0.1 mm or less.

6. The gas bag according to claim 1, characterized in that the threads (18, 20) of the seam, with the exception of the tear thread have a thickness of at least about 0.5 mm.

7. An occupant restraint system for helping to protect an occupant of a vehicle, said restraint system comprising:
an inflatable gas bag having first and second fabric layers superimposed on each other;
each of the first and second fabric layers having an outer surface and an inner surface opposite said outer surface, the inner surface of said fabric layers facing each other; and
at least one tether means comprising a seam comprising at least two under-threads arranged on the outer surface of the first and second fabric layers and laterally spaced apart from each other, and at least one upper thread extending between said under-threads and connecting them to the outer surface,
wherein one of the under-threads is constructed as a tear thread which breaks when said gas bag is inflated.

8. The occupant restraint system of claim 7 wherein the at least two under-threads are both arranged on the outer surface of the second fabric layer, and the upper thread extends on the outer surface of the first fabric layer.

9. The occupant restraint system of claim 7, wherein the at least two under-threads are arranged on opposite outer surfaces of the first and second fabric layers, and the upper thread extends on both of the outer surfaces of the first and second fabric layer.
